(19) United States
(12) Patent Application Publication
(10) Pub. No.: US 2009/0078682 A1
(43) Pub. Date: Mar. 26, 2009

(54) Insertion type resistance welding method for welding copper and aluminum tubing

(76) Inventor: Eric Feng, Exton, PA (US)

Correspondence Address: JAMES RAY & ASSOCIATES, 2640 PITCAIRN ROAD, MONROEVILLE, PA, 15416, US

(21) Appl. No.: 12/283,389

(22) Filed: Sep. 11, 2008

Related U.S. Application Data
(60) Provisional application No. 60/974,518, filed on Sep. 24, 2007.

(51) Int. Cl. B23K 31/02; B23K 11/00; B23K 11/36

(52) U.S. Cl. 219/61.1

(57) ABSTRACT

A method for welding aluminum and copper tubes. The method comprises the steps of forming an annulated end on a copper tube. That is followed by a step of inserting the annulated end of the copper tube into an aluminum tube and then placing the aluminum tube with the annulated end of the copper tube disposed therein into a resistance welding machine. There is a step of inserting a core rod through the copper tube and pushing the core rod to a juncture of the annulated end of the copper tube and the aluminum tube for allowing a welded joint to be formed. There is a step of rotating the core rod and exerting pressure on the welding joint and applying an electric current to ensure that the aluminum tube and annulated end of the copper tube are welded followed by the step of removing the welded tubing from the welding machine.

### CROSS REFERENCE TO RELATED APPLICATIONS

This application is closely related to and claims benefit from U.S. Provisional Application Ser. No. 60/974,518 filed Sep. 24, 2007.

### FIELD OF THE INVENTION

The present invention relates, in general, to welding, and more particularly, the present invention relates to insertion type resistance welding for increasing the strength of welded joints of aluminum and copper tubes.

### BACKGROUND OF THE INVENTION

Welding copper and aluminum piping can be a difficult process and the technology has not kept up with industry needs. A welded tube with joint length of more than seven millimeters and a helium leaking test of less than 1.3×10⁻¹¹ Pa m³ s⁻¹ is not in use yet. New welding technology and machines capable of this high caliber effectiveness are not being implemented in the welding industry. This lack of advancement in the welding industry results in more time-consuming work that ends up being more expensive for the customer.

Thus it would be advantageous if there were a simple and effective means of providing an apparatus that would enhance the quality and strength of welded joints, made from aluminum and copper tubing, without oxidation and corrosion on the joints' surface.

### SUMMARY OF THE INVENTION

In a first aspect the present invention provides a method for welding aluminum and copper tubes. The method comprises the steps of forming an annulated end on a copper tube. That is followed by a step of inserting the annulated end of the copper tube into an aluminum tube and then placing the aluminum tube with the annulated end of the copper tube disposed therein into a resistance welding machine. There is a step of inserting a core rod through the copper tube and pushing the core rod to a juncture of the annulated end of the copper tube and the aluminum tube for allowing a welded joint to be formed. There is a step of rotating the core rod and exerting pressure on the welding joint and applying an electric current to ensure that the aluminum tube and annulated end of the copper tube are welded followed by the step of removing the welded tubing from the welding machine.

In a second aspect the present invention provides in combination with a welding machine for welding copper tubing, having an annulated portion formed on one end thereof, and aluminum tubing the improvement comprises an apparatus for assisting in such welding. The apparatus includes a core rod formed of a predetermined material and having a predetermined shape for inserting through an interior of such copper tube. There is a first means for rotating the core rod when the core rod is inserted in the copper tube to a juncture where welding is to occur. A second means applies an electric current to such joint formed between the annulated portion of the copper tube and the aluminum tube for ensuring that the copper tube is welded to the aluminum tube.

### OBJECTS OF THE INVENTION

It is, therefore, one of the primary objects of the present invention to provide a method for welding copper to aluminum tubing.

Another object of the present invention is to provide an apparatus that utilizes a core rod for such welding.

Still another object of the present invention is to provide an apparatus wherein such core rod is rotated by means of a motor.

Yet, another object of the present invention is to provide a method for welding copper and aluminum tubing that includes forming an annulated end in the copper tubing for insertion into the aluminum tubing.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a step by step diagram showing the method of performing the welding of a copper tube to an aluminum tube.

FIG. 2 is a cutaway view of the interior surface of a welded joint of copper and aluminum.

FIG. 3 is a side perspective view of the outer surface of copper and aluminum tubes that have been welded.

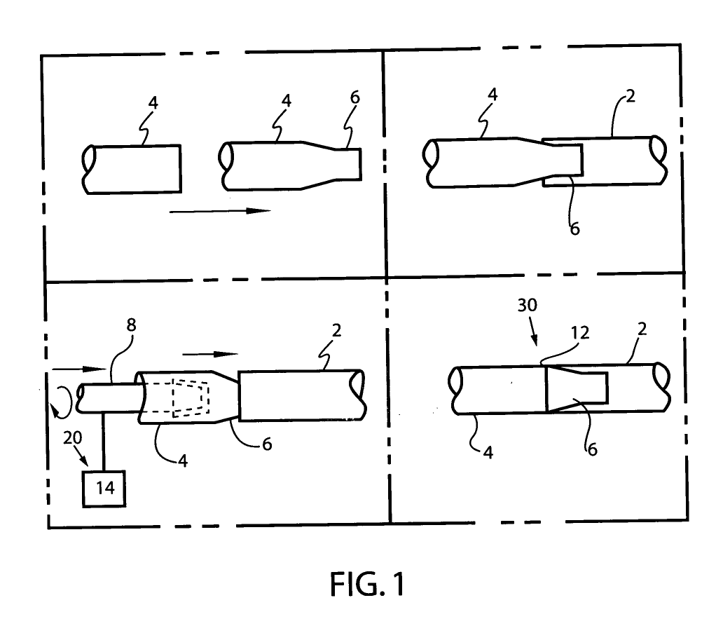

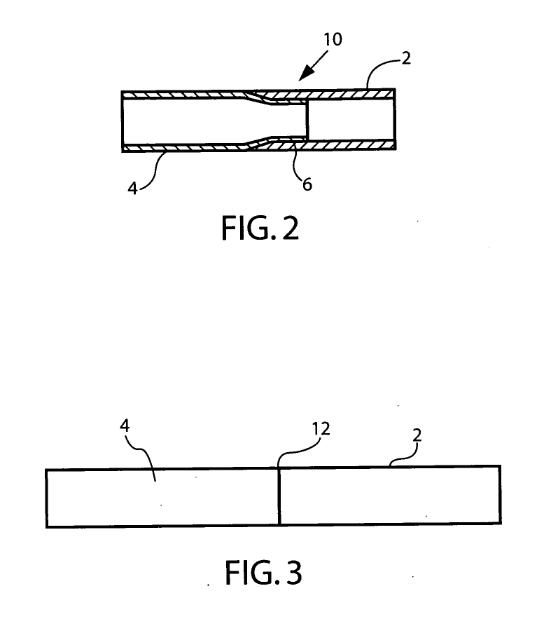

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides a method for welding aluminum 2 and copper tubes 4. The method comprises the steps of forming an annulated end 6 on a copper tube 4. That is followed by a step of inserting the annulated end 6 of the copper tube 4 into an aluminum tube 2 and then placing the aluminum tube 2 with the annulated end 6 of the copper tube 4 disposed therein into a resistance welding machine (not shown). There is a step of inserting a core rod 8 through the copper tube 4 and pushing the core rod 8 to a juncture of the annulated end 6 of the copper tube 4 and the aluminum tube 2 for allowing a welded joint 12 to be formed. There is a step of rotating the core rod 8 and exerting pressure on the welding joint 12 and applying an electric current three times to ensure that the aluminum tube 2 and annulated end 6 of the copper tube 4 are welded. This is followed by the step of removing the welded tubing from the welding machine.

Such method further includes steps (d),(e),(f) and (g) being done simultaneously and automatically. The method also includes a step of performing step (b) through step (g) within a predetermined time. The method includes producing a welded joint with a tensile strength that exceeds that of a pure aluminum tube 2.

The method wherein the step of rotating the core rod 8 includes using a motor 14 and the method further includes a step of selecting the core rod 8 from one of treated chromium steel and tungsten steel alloy. There is also a step of exerting pressure outwardly by the core rod 8.

In a second aspect the present invention provides in combination with a welding machine for welding copper tubing 4, having an annulated portion 6 formed on one end thereof, and aluminum tubing 2, the improvement comprises an apparatus 10 for assisting in such welding. The apparatus 10 includes a core rod 8 formed of a predetermined material and having a predetermined shape for inserting through an interior of such copper tube 4. There is a first means 20 for rotating the core rod 8 when the core rod 8 is inserted in the copper tube 4 to a juncture where welding is to occur. A second means 30 applies an electric current to such joint formed between the annulated portion 6 of the copper tube 4 and the aluminum tube 2 for ensuring that the copper tube 4 is welded to the aluminum tube 2.

Such first means 20 for rotating the core rod 8 includes a motor 14.

Such predetermined material for forming such core rod 8 is selected from one of treated chromium steel and tungsten steel alloy.

It should be noted that the core rod 8 has a specially designed head for different diameters of tubes being welded. The 10 specially designed head includes a pyramidal shape and wherein the pyramidal shape of the core rod 8 corresponds to the shape of the annulated portion 6 of the copper tube 4.

Thus, the new technique is designed to make aluminum and copper tube welding fast and leak proof in a one step operation is without the need of additional treatment. To do this the user would make an annulated insertion at the end of a copper tube which gives the tube a shrinking and circular appearance. The annulated portion is inserted into an aluminum tube and is placed in a welding machine. A core rod is inserted through the copper tube to the weld joint, the core rod is rotated and exerts an outward pressure on the weld joint. An electric current is applied to ensure that the tubes are excellently welded. The last two steps are processed simultaneously and automatically. The entire welding process only requires several seconds and offers a tensile strength of a welded joint that exceeds that of a pure aluminum tube with high, anti-crack properties. The weld is 100% guaranteed and gives a high quality product that offers a lower manufacturing cost if used in refrigeration and heating systems.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. A method for welding aluminum and copper tubes, said method comprising the steps of:
(a) forming an annulated end on a copper tube;
(b) inserting said annulated end of said copper tube into an aluminum tube;
(c) placing said aluminum tube with said annulated end of said copper tube disposed therein into a resistance welding machine;
(d) inserting a core rod through said copper tube;
(e) pushing said core rod to a juncture of said annulated end of said copper tube and said aluminum tube for allowing a welded joint to be formed;
(f) rotating said core rod and exerting pressure on said welding joint;
(g) applying an electric current three times to ensure that said aluminum tube and said annulated end of said copper tube are welded; and
(h) removing said welded tubing from said welding machine.

2. The method, according to claim 1, wherein method includes processing steps (d), (e), (f) and (g) simultaneously and automatically.

3. The method, according to claim 1, wherein said method includes performing step (b) through step (g) within a predetermined time.

4. The method, according to claim 3, wherein said method includes producing a welded joint with a tensile strength that exceeds that of a pure aluminum tube.

5. The method, according to claim 1, wherein said step of rotating said core rod includes using a motor.

6. The method, according to claim 1, wherein said method further includes a step of selecting said core rod from one of treated chromium steel and tungsten steel alloy.

7. The method, according to claim 1, wherein said method includes a step of exerting pressure outwardly by said core rod.

8. In combination with a welding machine for welding copper tubing, having an annulated portion formed on one end thereof, and aluminum tubing the improvement comprising an apparatus for assisting in such welding, said apparatus including:
(a) a core rod formed of a predetermined material and having a predetermined shape for inserting through an interior of said copper tube;
(b) a first means for rotating said core rod when said core rod is inserted in said copper tube to a juncture where welding is to occur; and
(e) a second means for applying an electric current to a joint formed between said annulated portion of said copper tube and said aluminum tube for ensuring that said copper tube is welded to said aluminum tube.

9. The combination, according to claim 8, wherein said first means includes a motor.

10. The combination, according to claim 8, wherein said predetermined material for forming said core rod is selected from one of treated chromium steel and tungsten steel alloy.

11. The combination, according to claim 8, wherein said core rod has a specially designed head for different diameters and thickness of tubes being welded.

12. The combination, according to claim 11, wherein said specially designed head includes a pyramidal shape.

13. The combination, according to claim 12, wherein said pyramidal shape of said core rod corresponds to a shape of said annulated portion of copper tube.

14. The combination, according to claim 8, wherein said core rod exerts pressure outwardly on said juncture where welding is to occur.

15. The combination, according to claim 8, wherein said welding of said copper tube to said aluminum tube produces a welded joint with a tensile strength that exceeds that of a pure aluminum tube.

16. The combination, according to claim 8, wherein such welding of said copper tubing to said aluminum tubing with use of said apparatus requires less than 10 seconds.
